(19) United States
(12) Patent Application Publication
(10) Pub. No.: US 2025/0269329 A1
(43) Pub. Date: Aug. 28, 2025

(54) MICROFLOW SYNTHESIS UNIT

(71) Applicant: Panasonic Intellectual Property Management Co., Ltd., Osaka (JP)

(72) Inventors: Ryo MIYA, Osaka (JP); Taichi NAKAMURA, Osaka (JP); Hiroaki YOSHIDA, Osaka (JP)

(21) Appl. No.: 19/207,439

(22) Filed: May 14, 2025

Related U.S. Application Data
(63) Continuation of application No. PCT/JP2023/034165, filed on Sep. 20, 2023.

(30) Foreign Application Priority Data
Nov. 29, 2022 (JP) 2022-190483

(51) Int. Cl. B01D 61/54; B01D 61/42; B01D 61/46; B01J 19/00

(52) U.S. Cl. CPC B01D 61/54; B01D 61/423; B01D 61/461; B01J 19/0093; B01D 2317/02; B01J 2219/00889; B01J 2219/00907; B01J 2219/00912; B01J 2219/00957

(57) ABSTRACT

A microflow synthesis unit includes a mixing channel part for mixing a plurality of fluids to create a mixed fluid including ions, an ion separator that separates the ions from the mixed fluid, the ion separator being connected downstream of the mixing channel part, an ionic conductivity detector that detects an ionic conductivity of the mixed fluid, the ionic conductivity detector being connected downstream of the ion separator, an arithmetic part that calculates an arithmetic value based on the ionic conductivity detected by the ionic conductivity detector, and a controller that controls the ion separator based on the arithmetic value, wherein the ion separator includes two or more electrodialysis parts having an electrodialysis function, and each of the two or more electrodialysis parts includes a corresponding one of two or more voltage application parts.

### TECHNICAL FIELD

The present disclosure relates to an apparatus for mixing liquids having solubility with each other in a microchannel, in particular, a microflow synthesis unit.

### BACKGROUND ART

Conventionally, as a method for producing a desired reaction product by bringing liquids (reactants) having solubility with each other into contact with each other and mixing the liquids, a method using a channel formation body, that is, a so-called microreactor, is known (see, for example, PTL 1). The microreactor includes a substrate formed with a groove on the surface, and the groove forms a microchannel. Allowing the liquids to be mixed to flow in the microchannel dramatically increases the contact area between the liquids to be mixed per unit volume, which increases the efficiency of mixing the liquids to be mixed.

To stabilize the quality in this microreactor, it is desirable to separate the raw materials remaining in the liquid mixed in the microchannel after mixing and then take out a reaction product. Such separation of unreacted raw materials stops the progress of excessive reactions and side reactions in the microchannel and the collection container, thereby making it possible to obtain a desired reaction product with high quality.

Here, as an apparatus for separating ions in a liquid, for example for production of pure water or ultrapure water, an electrodialyzer is disclosed (see, for example, PTL 1). The term “electrodialyzer” as used herein refers to an apparatus including: an electrodialyzer body in which, for example, a cation permeable membrane and an anion permeable membrane are alternately disposed to face each other, and a desalination chamber and a salt concentration chamber are formed in a stacking manner; a channel for water to be treated and treatment water as a first liquid for flowing the water to be treated into each desalination chamber and discharging the treatment water; a channel for a second liquid for flowing the second liquid into and discharging the second liquid from the salt concentration chamber; an anode and a cathode disposed on both end sides facing each other in a stacking direction of the electrodialyzer; and a voltage application part that applies an electric field to the anode and the cathode to move ions in the water to be treated flowing into the desalination chamber to the salt concentration chamber. Using such an electrodialyzer makes it possible to perform desalination (ion separation) in raw water (water to be treated) with high electrical efficiency in mass production or industry. By incorporating the present electrodialyzer function into a microreactor, a reaction product can be obtained with both high mixing efficiency and stable quality.

### CITATION LIST

### Patent Literature

PTL 1: Japanese Patent No. 3188511

### SUMMARY OF THE INVENTION

A microflow synthesis unit according to one aspect of the present disclosure includes a mixing channel part for mixing a plurality of fluids to create a mixed fluid including ions, an ion separator that separates the ions from the mixed fluid, the ion separator being connected downstream of the mixing channel part, an ionic conductivity detector that detects an ionic conductivity of the mixed fluid, the ionic conductivity detector being connected downstream of the ion separator, an arithmetic part that calculates an arithmetic value based on the ionic conductivity detected by the ionic conductivity detector, and a controller that controls the ion separator based on the arithmetic value, wherein the ion separator includes two or more electrodialysis parts having an electrodialysis function, and each of the two or more electrodialysis parts includes a corresponding one of two or more voltage application parts.

### BRIEF DESCRIPTION OF THE DRAWINGS

FIG. 1 is a schematic view illustrating a configuration of a microflow synthesis unit according to a first exemplary embodiment.

FIG. 2 is a schematic view illustrating a configuration of a microflow synthesis apparatus according to the first exemplary embodiment.

FIG. 3 is a schematic view illustrating a configuration of an ion separator according to the first exemplary embodiment.

FIG. 4A is a schematic view illustrating a case where synthetic particles are not attached to a cation permeable membrane and an anion permeable membrane in the microflow synthesis unit according to the first exemplary embodiment.

FIG. 4B is a schematic view illustrating a case where negatively charged synthetic particles are attached to the anion permeable membrane and the anion separation performance has lowered in the microflow synthesis unit according to the first exemplary embodiment.

FIG. 4C is a schematic view illustrating a case where negatively charged synthetic particles are attached to the anion permeable membrane, the anion separation performance has lowered, and a second electrodialysis part is operated by switching the voltage application direction of a first electrodialysis part in the microflow synthesis unit according to the first exemplary embodiment.

FIG. 5A is a graph showing a temporal change in ionic conductivity of a post-merging liquid that has passed through an ionic conductivity detector in the microflow synthesis unit according to the first exemplary embodiment.

FIG. 5B is a graph showing a time change in ionic conductivity of the post-merging liquid that has passed through the ionic conductivity detector when ion separator 40 does not include at least two or more electrodialysis parts, and each of the electrodialysis parts does not have a different voltage application part in the microflow synthesis unit according to the first exemplary embodiment.

FIG. 6 is a flowchart of a control mechanism in the microflow synthesis apparatus according to the first exemplary embodiment.

### DESCRIPTION OF EMBODIMENT

When the apparatus described in PTL 1 is applied to a fine particle synthesis application using a microreactor, fine particles having positive or negative charges on the particle surface attach to the cation permeable membrane and the anion permeable membrane because of a voltage applied to the anode and the cathode, and the separation performance of the raw material ions decreases, which causes progression of excessive reaction in the microchannel and the collection container and quality variation due to side reactions.

An object of the present disclosure is to provide a microflow synthesis unit capable of performing high-quality fine particle synthesis through stable separation of unreacted raw material ions in fine particle synthesis using a microreactor.

A microflow synthesis unit according to a first aspect includes a mixing channel part for mixing a plurality of fluids to create a mixed fluid including ions, an ion separator that separates the ions from the mixed fluid, the ion separator being connected downstream of the mixing channel part, an ionic conductivity detector that detects an ionic conductivity of the mixed fluid, the ionic conductivity detector being connected downstream of the ion separator, an arithmetic part that calculates an arithmetic value based on the ionic conductivity detected by the ionic conductivity detector, and a controller that controls the ion separator based on the arithmetic value, wherein the ion separator includes two or more electrodialysis parts having an electrodialysis function, and each of the two or more electrodialysis parts includes a corresponding one of two or more voltage application parts.

In a microflow synthesis unit according a second aspect, in the first aspect, each of the two or more electrodialysis parts may further include, in a pipe installed in parallel to a channel along a flow direction of the mixed fluid, a cation permeable membrane and an anion permeable membrane that are installed in parallel with the channel interposed therebetween, the cation permeable membrane and the anion permeable membrane being spaced apart from a wall surface of the pipe, and an electrode part installed on the wall surface of the pipe, and each of the two or more voltage application parts may apply a voltage to the electrode part of the corresponding one of the two or more electrodialysis parts to move ions of the mixed fluid flowing into the pipe to an outside of the cation permeable membrane and the anion permeable membrane.

In a microflow synthesis unit according a third aspect, in the first or second aspect, the arithmetic part may calculate a statistic based on the ionic conductivity detected by the ionic conductivity detector, set a threshold value of the ionic conductivity, and send a signal to the controller.

In a microflow synthesis unit according a fourth aspect, in the first or second aspect, the microflow synthesis unit may further include a collection part downstream of the ionic conductivity detector, and the collection part may include a channel switch part that switches a channel depending on whether the mixed fluid is a synthetic liquid or a waste liquid based on the ionic conductivity of the mixed fluid detected by the ionic conductivity detector, a synthetic liquid collection part that collects the synthetic liquid, the synthetic liquid collection part being connected downstream of the channel switch part, and a waste liquid collection part that collects the waste liquid, the waste liquid collection part being connected downstream of the channel switch part.

In a microflow synthesis unit according a fifth aspect, in the third aspect, the microflow synthesis unit may further include a collection part downstream of the ionic conductivity detector, and the collection part may include a channel switch part that switches a channel depending on whether the mixed fluid is a synthetic liquid or a waste liquid based on the ionic conductivity of the mixed fluid detected by the ionic conductivity detector, a synthetic liquid collection part that collects the synthetic liquid, the synthetic liquid collection part being connected downstream of the channel switch part, and a waste liquid collection part that collects the waste liquid, the waste liquid collection part being connected downstream of the channel switch part.

The microflow synthesis unit according to an aspect of the present disclosure can stably separate unreacted raw material ions by suppressing lowering in separation performance due to attachment of fine particles to an ion permeable membrane in fine particle synthesis.

Hereinafter, microflow synthesis unit 1 and microflow synthesis apparatus 2 according to an exemplary embodiment will be described with reference to the accompanying drawings. In the drawings, substantially the same members are denoted by the same reference numerals.

### First Exemplary Embodiment

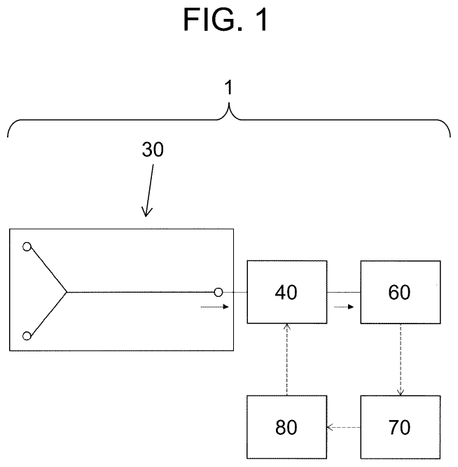

FIG. 1 is a schematic view illustrating a configuration of microflow synthesis unit 1 according to a first exemplary embodiment. Microflow synthesis unit 1 is used for mixing a plurality of fluids in a mixing channel to create a mixed fluid. Specifically, the microflow synthesis unit includes at least mixing channel 30 for mixing a plurality of fluids to create a mixed fluid, ion separator 40 that is connected downstream of mixing channel 30 and separates ions in the mixed fluid of the plurality of fluids, ionic conductivity detector 60 that is connected downstream of ion separator 40 and detects an ionic conductivity of the mixed fluid, arithmetic part 70 that calculates an arithmetic value based on the ionic conductivity detected by ionic conductivity detector 60, and controller 80 that controls ion separator 40 based on the arithmetic value. Ion separator 40 includes at least two or more electrodialysis parts having an electrodialysis function. Each electrodialysis part has a different voltage application part. In FIG. 1, the flow of the mixed fluid is indicated by solid lines, and the measured value of the ionic conductivity and the flow of the signal based on the measured value are indicated by dotted lines.

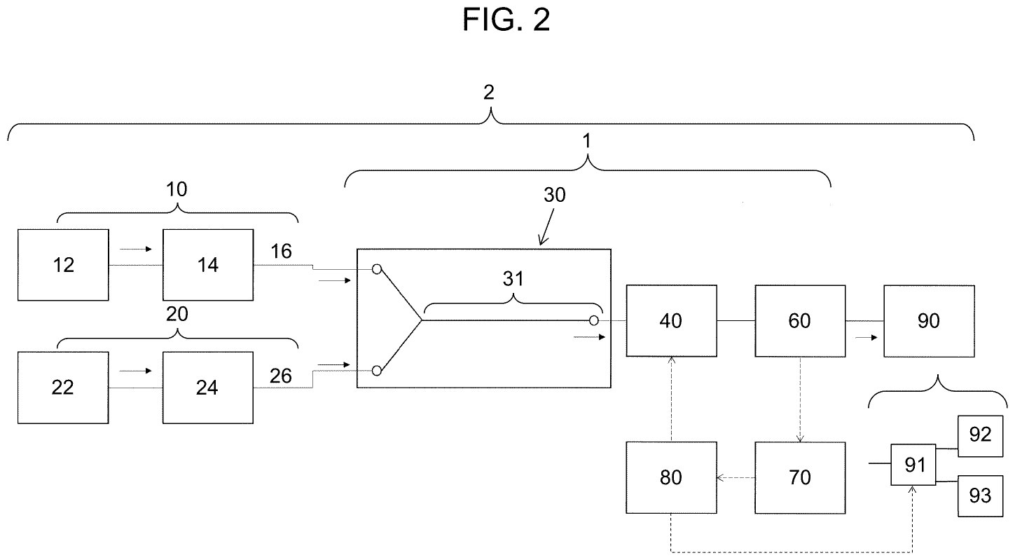

FIG. 2 is a schematic view illustrating a configuration of microflow synthesis apparatus 2 according to the first exemplary embodiment.

Microflow synthesis apparatus 2 is used for mixing a first liquid and a second liquid having solubility with each other and performing fine particle synthesis. Specifically, microflow synthesis apparatus 2 includes first liquid supply part 10 that supplies the first liquid, second liquid supply part 20 that supplies the second liquid, microflow synthesis unit 1 that mixes a plurality of fluids in a mixing channel to create a mixed fluid containing fine particles, and collection part 90 that is connected downstream of ionic conductivity detector 60 and collects the fine particles. Also in FIG. 2, the flow of each fluid and the mixed fluid is indicated by solid lines, and the measured value of the ionic conductivity and the flow of the signal based on the measured value are indicated by dotted lines.

Hereinafter, each member constituting microflow synthesis unit 1 and microflow synthesis apparatus 2 will be described.

### <First Liquid Supply Part>

As an example, first liquid supply part 10 includes first liquid container 12 that accommodates a first liquid, first liquid pump 14 that pressure-feeds the first liquid in first liquid container 12 to microflow synthesis unit 1, and a first liquid channel 16 that connects an inside of first liquid container 12 and microflow synthesis unit 1.

### <Second Liquid Supply Part>

In the same manner, second liquid supply part 20 includes, as an example, second liquid container 22 that accommodates a second liquid, second liquid pump 24 that pressure-feeds the second liquid in second liquid container 22 to microflow synthesis unit 1, and second liquid channel 26 that connects an inside of second liquid container 22 and microflow synthesis unit 1.

### <Microflow Synthesis Unit>

As an example, microflow synthesis unit 1 includes mixing channel 30 for mixing the first liquid and the second liquid to create a liquid (hereinafter, the liquid is referred to as “post-merging liquid”) containing the first liquid, the second liquid, and fine particles that are a reaction product of the first liquid and the second liquid, ion separator 40 that separates remaining unreacted ion components from the post-merging liquid, ionic conductivity detector 60 that detects an ionic conductivity of the post-merging liquid, arithmetic part 70 that calculates an arithmetic value based on the ionic conductivity detected by ionic conductivity detector 60, and controller 80 that controls an operation of ion separator 40 based on the arithmetic value.

In the first exemplary embodiment, an example has been described in which two liquids are brought into contact with each other and mixed in mixing channel 30 to produce a desired reaction product, but the present disclosure is not limited to this example. For example, when the reaction product is produced with two or more liquids, the same configuration as first liquid supply part 10 and second liquid supply part 20 may be provided in parallel.

First liquid supply part 10 and second liquid supply part 20 may appropriately perform necessary temperature control through a synthesis process for a target reaction product. For example, a thermostatic bath or the like may be used to change the temperature of the first and second liquids supplied to microflow synthesis unit 1, but this is not illustrated because this is omitted in the present exemplary embodiment.

The main components of the first liquid and the second liquid to be disclosed in the present disclosure are water in the present exemplary embodiment, but the first liquid and the second liquid may be water soluble liquids or water insoluble liquids as long as they have solubility with each other. For example, both the liquids may be water or aqueous solutions, or both the liquids may be organic solvents or oil-based liquids. The mixing ratio and the concentration can also be freely set.

### <Mixing Channel>

Mixing channel 30 includes mixing channel part 31 that mixes the first liquid and the second liquid to create the post-merging liquid.

The channel diameter of mixing channel part 31 in the microflow synthesis unit according to the first exemplary embodiment of the present disclosure may be set within a range functioning as a micromixer or a microreactor, and the diameter may be, for example, 0.1 [mm] to 1.0 [mm].

Mixing channel 30 according to the exemplary embodiment of the present disclosure can be used by connecting flow paths produced by bonding, or stacking and fixing flat plates with a groove, metal tubes, resin tubes, and the like. As a material of the flat plate, for example, a metal material such as a stainless alloy, copper, titanium, or HASTELLOY, a glass material such as quartz glass or borosilicate glass, or a resin material such as vinyl chloride, PP, PFA, PTFE, ETFE, PEEK, or PPS can be used. As a material of the metal tube, a stainless alloy, copper, or the like can be used. As a material of the resin tube, PP, PFA, PTFE, ETFE, PEEK, PPS, or the like can be used.

### <Ion Separator>

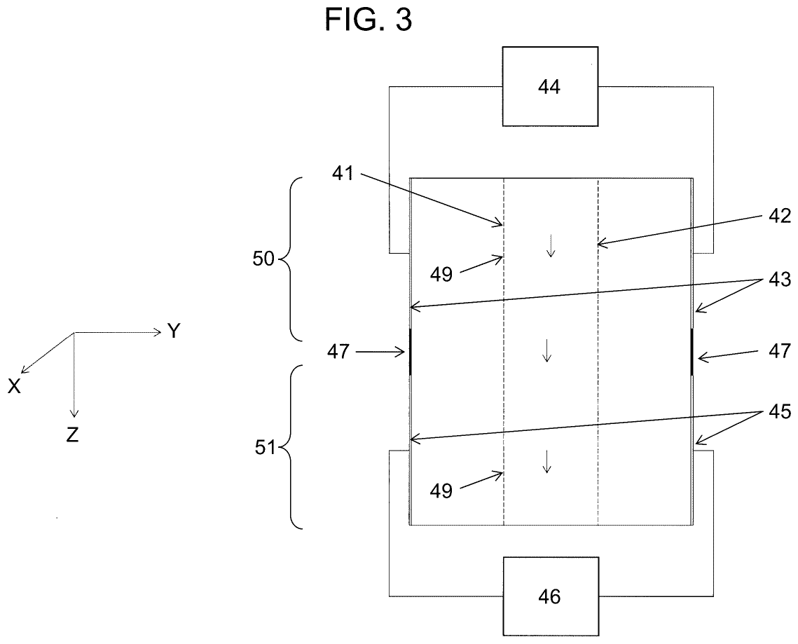

Ion separator 40 separates remaining unreacted ion components from the post-merging liquid. Ion separator 40 includes at least two or more electrodialysis parts having an electrodialysis function. Each electrodialysis part has a different voltage application part. An example of the configuration of ion separator 40 will be described later together with the description of FIG. 3.

### <Ionic Conductivity Detector>

Ionic conductivity detector 60 is formed by using, for example, an AC two-terminal type or AC four-terminal type ionic conductivity sensor, and it detects the ionic conductivity of the post-merging liquid flowing in the tube.

### <Arithmetic Part, Controller>

Arithmetic part 70 calculates an arithmetic value from the ionic conductivity detected by ionic conductivity detector 60. The arithmetic value is, for example, a statistic such as an average value or a standard deviation.

Controller 80 controls the operation of ion separator 40 based on the arithmetic value calculated by arithmetic part 70.

For example, a general-purpose computer or the like can be used as each of arithmetic part 70 and controller 80. Arithmetic part 70 and controller 80 may be separate bodies or may be integrated.

### <Detailed Configuration of Ion Separator>

FIG. 3 is a schematic view illustrating a configuration of ion separator 40 in the microflow synthesis unit according to the first exemplary embodiment.

In the first exemplary embodiment, as an example, ion separator 40 includes first electrodialysis part 50 and second electrodialysis part 51 installed in series along the flowing direction (Z direction) of the post-merging fluid.

First electrodialysis part 50 includes, in a pipe installed in parallel to a channel along the direction (Z direction) in which the post-merging liquid flows, cation permeable membrane 41 and anion permeable membrane 42 that are disposed in parallel to each other with the channel interposed therebetween and spaced apart from a wall surface of the pipe, first electrode part 43 disposed on the wall surface of the pipe, and first voltage application part 44 that applies a voltage to first electrode part 43 to move the remaining unreacted ion component of the post-merging liquid flowing into the pipe to the outside of cation permeable membrane 41 and anion permeable membrane 42. Cation permeable membrane 41 and anion permeable membrane 42 include hole 49 that allows ions to permeate. Hole 49 is schematically illustrated, and is not limited to the illustrated form as long as it allows ions to permeate.

In the same manner, second electrodialysis part 51 includes, in a pipe installed in parallel to a channel along the direction (Z direction) in which the post-merging liquid flows, cation permeable membrane 41 and anion permeable membrane 42 that are disposed in parallel to each other with the channel interposed therebetween and spaced apart from a wall surface of the pipe, second electrode part 45 disposed on the wall surface of the pipe, and second voltage application part 46 that applies a voltage to second electrode part 45 to move the remaining unreacted ion component of the post-merging liquid flowing into the pipe to the outside of cation permeable membrane 41 and anion permeable membrane 42.

First electrode part 43 and second electrode part 45 are connected by insulator 47 so that first electrodialysis part 50 and second electrodialysis part 51 can function independently. For insulator 47, an insulating materials such as fluororesin or glass can be used.

The length of insulator 47 along the flow direction (Z direction) is preferably short as long as first electrodialysis part 50 and second electrodialysis part 51 can function independently, and the length can be, for example, 0.1 [mm] to 1.0 [mm].

In the first exemplary embodiment, cation permeable membrane 41 and anion permeable membrane 42 are common to first electrodialysis part 50 and second electrodialysis part 51, but the cation permeable membrane and the anion permeable membrane may be provided in each of first electrodialysis part 50 and second electrodialysis part 51.

X and Y in FIG. 3 refer to a direction (horizontal direction) orthogonal to gravity, and Z represents the gravity direction. The “flow direction” described above means the Z direction in FIG. 3, and when the post-merging liquid flows in the Z (gravity) direction, the particles attached to ion separator 40 easily flow to the collection part.

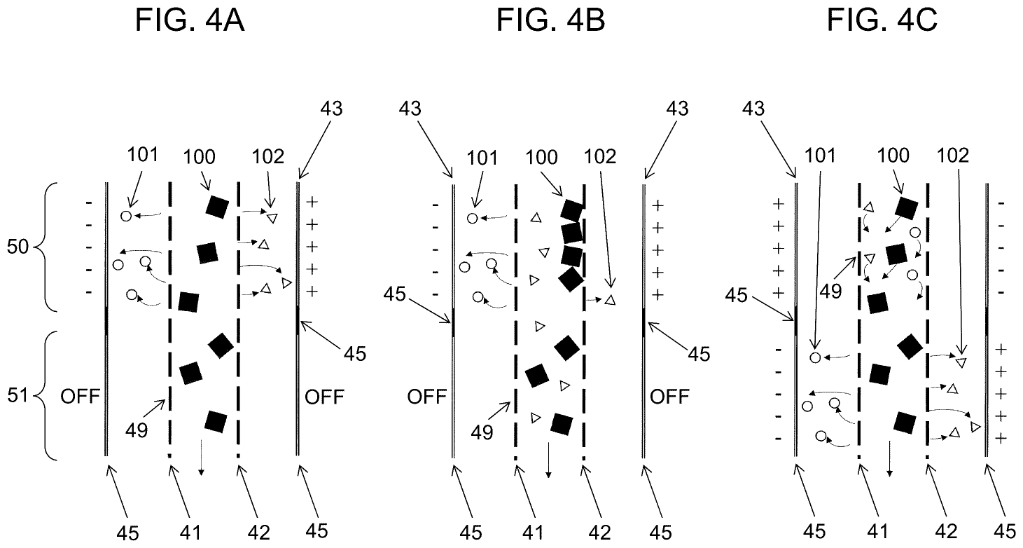

FIG. 4A is a schematic view illustrating a case where synthetic particles 100 are not attached to cation permeable membrane 41 and anion permeable membrane 42 in the microflow synthesis unit according to the first exemplary embodiment, FIG. 4B is a schematic view illustrating a case where negatively charged synthetic particles 100 are attached to anion permeable membrane 42, and the separation performance of anions 102 has lowered in the microflow synthesis unit according to the first exemplary embodiment, and FIG. 4C is a schematic view illustrating a case where negatively charged synthetic particles 100 are attached to anion permeable membrane 42, the separation performance of anions 102 has lowered in the microflow synthesis unit according to the first exemplary embodiment, and the voltage application direction of first electrodialysis part 50 is switched to operate second electrodialysis part 51.

As illustrated in FIG. 4A, when synthetic particles 100 are not attached to cation permeable membrane 41 and anion permeable membrane 42, for example, immediately after the start of synthesis, hole 49 that allows ions to permeate is open. Thus, cation 101 and anion 102 are stably separated in first electrodialysis part 50, and high-quality fine particles can be synthesized.

On the other hand, synthetic particles 100 in the post-merging liquid have positive or negative charges on the particle surface. For this reason, for example, when the particle surface is negatively charged, and the present apparatus is continuously operated, negatively charged synthetic particles 100 attach to anion permeable membrane 42 as illustrated in FIG. 4B, and many of holes 49 that allow ions to permeate are blocked. This lowers the separation performance of anion 102 in first electrodialysis part 50.

Thus, as illustrated in FIG. 4C, the voltage application direction of first electrodialysis part 50 is switched at an appropriate timing to operate second electrodialysis part 51. Switching of the voltage application direction of first electrodialysis part 50 makes it possible to remove synthetic particles 100 attached to the anionic permeable membrane 42 of first electrodialysis part 50 and open holes 49 that allow ions to permeate. Operation of second electrodialysis part 51 enables separation of cation 101 and anion 102 at second electrodialysis part 51. As a result, even when the apparatus is continuously operated, high-quality fine particles can be synthesized through stable separation of unreacted raw material ions.

In addition, second electrodialysis part 51 may be continuously operated, but the second electrodialysis part is desirably stopped after a certain period of time to prevent synthetic particles 100 from attaching to cation permeable membrane 41 and anion permeable membrane 42 of second electrodialysis part 51.

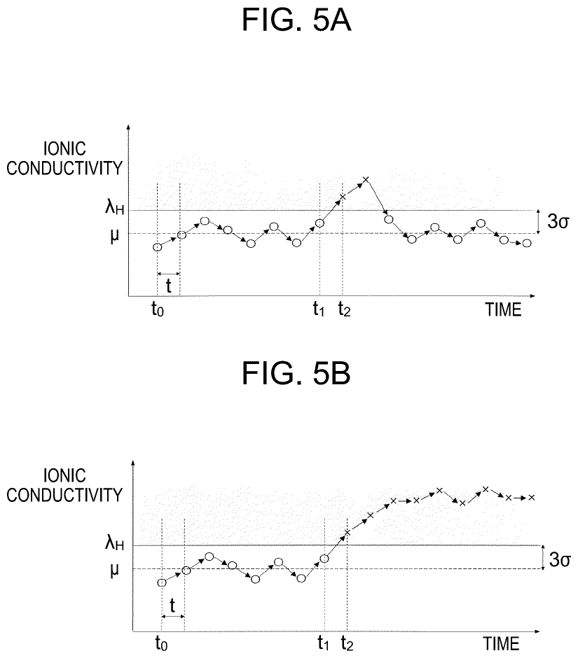

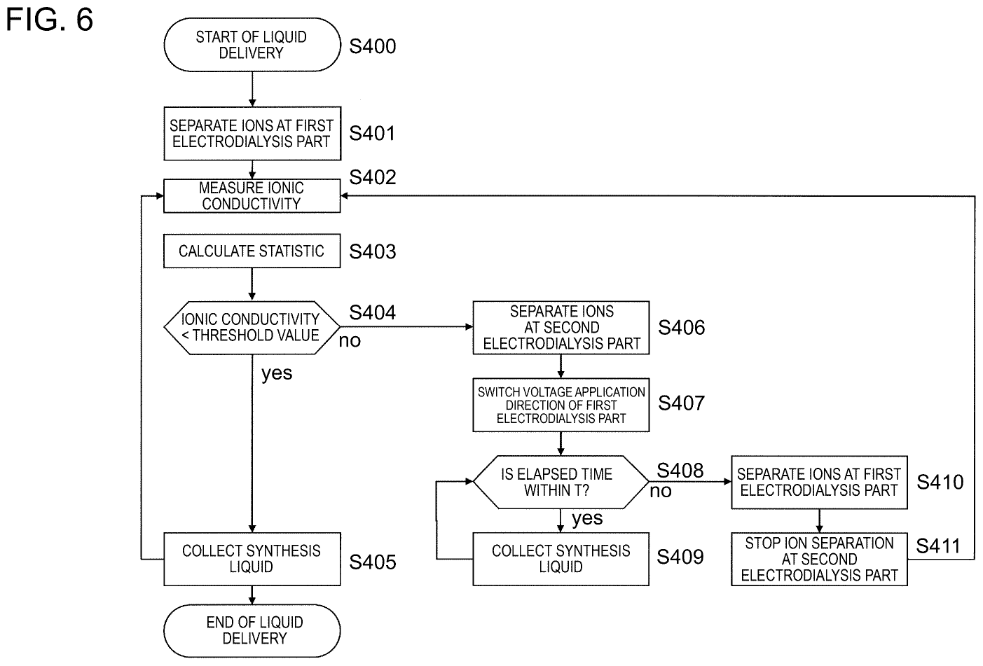

An operation example of first electrodialysis part 50 and second electrodialysis part 51 will be described later together with the description of FIGS. 5A, 5B, and 6.

FIG. 5A is a graph showing a temporal change in ionic conductivity of the post-merging liquid that has passed through ionic conductivity detector 60 in the microflow synthesis unit according to the first exemplary embodiment, and FIG. 5B is a graph showing a temporal change in ionic conductivity of the post-merging liquid that has passed through ionic conductivity detector 60 when ion separator 40 does not have at least two or more electrodialysis parts, and each of the electrodialysis parts does not have a different voltage application part in the microflow synthesis apparatus according to a reference example.

First, it is known that the ionic conductivity in a solution increases with an increase in ion concentration. For example, the ionic conductivity of an NaCl aqueous solution at room temperature takes a value of about 2.0 [mS/cm] at a concentration of 0.1 [%], a value of about 18.0 [mS/cm] at a concentration of 1.0 [%], and a value of about 34.0 [mS/cm] at a concentration of 2.0 [%]. In this manner measuring the ionic conductivity of the post-merging liquid makes it possible to quantitatively evaluate an increase or decrease of unreacted raw material ions in the post-merging liquid.

In microflow synthesis apparatus 2 according to the first exemplary embodiment, as illustrated in FIG. 5A, second electrodialysis part 51 is operated at the timing when the ionic conductivity of the post-merging liquid that has passed through ionic conductivity detector 60 has exceeded threshold value λ_{H}. With this operation, ions are separated by second electrodialysis part 51 instead of first electrodialysis part 50 in which the ion separation performance has lowered, and thus it is possible to synthesize high-quality fine particles while suppressing lowering of ion separation performance.

Further, in first electrodialysis part 50 in which the ion separation performance has lowered, it is possible to remove synthetic particles 100 attached to cation permeable membrane 41 and anion permeable membrane 42 by switching the voltage application direction.

On the other hand, in the microflow synthesis apparatus according to the reference example, when ion separator 40 does not include at least two or more electrodialysis parts and when each of the electrodialysis parts does not have a different voltage application part, synthetic particles 100 attach to cation permeable membrane 41 and anion permeable membrane 42 in ion separator 40, and the separation performance of cation 101 and anion 102 lowers when the present apparatus is continuously operated, since synthetic particles 100 in the post-merging liquid have positive or negative charges on the particle surface. That is, as illustrated in FIG. 5B, an increase in the ionic conductivity detected by ionic conductivity detector 60, that is, quality variation due to unreacted cation 101 and anion 102 occurs.

Thus, microflow synthesis apparatus 2 according to the first exemplary embodiment has at least two or more electrodialysis parts, and each of the electrodialysis parts has a different voltage application part, thereby enabling high-quality fine particle synthesis through stable separation of unreacted raw material ions.

Hereinafter, an example of a method for setting threshold value λ_{H} of the ionic conductivity for determining the timing of operating second electrodialysis part 51 will be described. First, ionic conductivity detector 60 measures the ionic conductivity at time interval t from the synthesis start time point. Arithmetic part 70 calculates statistics μ and λ_{H} of the ionic conductivity by using the values of the ionic conductivity measured up to time t₁. Statistic μ is an average value of the ionic conductivities measured up to time t₁. Statistic λ_{H} is a value (μ+3σ) obtained by adding a value three times standard deviation σ of the ionic conductivities measured until time t₁ to the average value of the ionic conductivities measured up to time t₁. In this manner, arithmetic part 70 sets threshold value λ_{H} from the actually measured ionic conductivity. When the ionic conductivity at the time t₂ has exceeded threshold value λ_{H}, arithmetic part 70 sends a signal to controller 80. In response to the signal, controller 80 switches the voltage application direction of first electrodialysis part 50 to operate second electrodialysis part 51. Threshold value λ_{H} can be set to μ+σ or μ+2σ depending on the quality of the desired reaction product, or the upper limit value of the ionic conductivity of the post-merging liquid that allows quality variation may be measured in advance and used.

It is known that 99.73% of the total number is included in the range of μ−3σ to μ+3σ when the measured values of the ionic conductivity have a normal distribution. That is, it can be said that the range from μ−3σ to μ+3σ is substantially the range of the normal distribution. Thus, it is considered that statistic λ_{H} of the ionic conductivity substantially indicates the upper limit threshold value of the range of the normal distribution. Comparing the measured value of the ionic conductivity with threshold value λ_{H} makes it possible to determine whether the measured value of the ionic conductivity is within the range of the normal distribution.

When the ionic conductivity at time t₂ has exceeded threshold value λ_{H}, controller 80 measures the elapsed time from when the voltage application direction of first electrodialysis part 50 is switched and second electrodialysis part 51 is activated. After time T has elapsed, controller 80 switches the voltage application direction of first electrodialysis part 50 again to stop second electrodialysis part 51. Time T may be set by measuring in advance the time required for the attachment of synthetic particles 100 to cation permeable membrane 41 and anion permeable membrane 42 to be improved, or difference (t₂−t₀) between measurement start time t₀ and time t₂ at which the ionic conductivity exceeds threshold value λ_{H} may be used.

When the voltage application direction of first electrodialysis part 50 is switched, and second electrodialysis part 51 is operated or stopped, side reactions and the like may occur, and the quality of the reaction product may decrease. Collection part 90 may include channel switch part 91, synthetic liquid collection part 92, and waste liquid collection part 93. Based on the ionic conductivity of the mixed fluid detected by ionic conductivity detector 60, channel switch part 91 switches the channel depending on whether the mixed fluid is a synthetic liquid or a waste liquid. Synthetic liquid collection part 92 is connected downstream of channel switch part 91 and collects the synthetic liquid. Waste liquid collection part 93 is connected downstream of channel switch part 91 and collects the waste liquid. When the voltage application direction of first electrodialysis part 50 is switched and second electrodialysis part 51 is operated or stopped, controller 80 controls channel switch part 91 to switch the channel from synthetic liquid collection part 92 to waste liquid collection part 93. Waste liquid collection part 93 collects the post-merging liquid. The illustration of the waste liquid collection part is omitted because it is omitted in the present exemplary embodiment.

Here, a case where microflow synthesis unit 1 (FIG. 1) includes no collection part, and microflow synthesis apparatus 2 (FIG. 2) includes collection part 90 has been described, but the present disclosure is not limited to this case. For example, the microflow synthesis unit may include a collection part.

Next, FIG. 6 illustrates a flowchart of a control mechanism in the microflow synthesis apparatus according to the present exemplary embodiment.
(1) In execution of the control algorithm of the liquid delivery control mechanism in FIG. 6, first, liquid delivery in first liquid supply part 10 and second liquid supply part 20 starts (S400).
(2) Next, separation of ions in the post-merging liquid starts in first electrodialysis part 50 (S401). Steps of S400 and S401 may be reversed or simultaneous.
(3) Next, ionic conductivity detector 60 starts detection of the ionic conductivity in the post-merging liquid (S402).
(4) Next, arithmetic part 70 calculates a statistic from the ionic conductivity value detected in S402 (S403).
(5) Next, the value of the ionic conductivity detected by ionic conductivity detector 60 is compared with the arithmetic value (threshold value) derived in S403, and when the ionic conductivity falls within the range of the threshold value (S404), the synthesis liquid is collected (S405).

As an example of “the ionic conductivity falls within the range of the threshold value” described here, as illustrated in FIG. 5A, there is a case where the ionic conductivity at time t₂ falls below threshold value λ_{H} (μ+3σ) calculated from the ionic conductivity value measured up to time t₁. In addition, an upper limit value of the ionic conductivity of the post-merging liquid that allows quality variation may be measured in advance, and the value may be used.
(6) Next, the value of the ionic conductivity detected by ionic conductivity detector 60 is compared with the arithmetic value (threshold value) calculated in S403, and when the ionic conductivity does not fall within the range of the threshold value (S404), separation of ions in the post-merging liquid starts in second electrodialysis part 51 (S406).

As an example of “the ionic conductivity does not fall within the range of the threshold value” described here, as illustrated in FIG. 5A, there is a case where the ionic conductivity at time t₂ exceeds threshold value λ_{H} calculated from the value of the ionic conductivity measured by time t₁.
(7) Next, the voltage application direction of first electrodialysis part 50 is switched (S407). Through the operations of S406 and S407, second electrodialysis part 51 can separate ions in the post-merging liquid instead of first electrodialysis part 50, and at the same time, synthetic particles 100 attached to cation permeable membrane 41 and anion permeable membrane 42 of first electrodialysis part 50 can be removed.
(8) Next, when the elapsed time is within T after the operation of S407 (S408), the synthesis liquid is collected (S409).
(9) When the elapsed time does not exceed T in S408, the operations in S408 and S409 are repeated.
(10) Next, when the elapsed time has exceeded T after the operation of S407 (S408), separation of ions in the post-merging liquid starts again in first electrodialysis part 50 (S410).

As described above, time T may be set by measuring in advance the time required for the attachment of synthetic particles 100 to cation permeable membrane 41 and anion permeable membrane 42 to improve, or difference (t₂−t₀) between measurement start time t₀ and time t₂ at which the ionic conductivity exceeds threshold value λ_{H} may be used.

Since synthetic particles 100 attached to cation permeable membrane 41 and anion permeable membrane 42 of first electrodialysis part 50 are removed by the operations of S406 and S407, first electrodialysis part 50 can separate ions in the post-merging liquid again.
(11) Next, the separation of ions in the post-merging liquid stops in second electrodialysis part 51 (S411).

Although second electrodialysis part 51 may be continuously operated without performing the operation of S411, it is desirable to perform the operation of S411 since it is possible to prevent synthetic particles 100 from attaching to cation permeable membrane 41 and anion permeable membrane 42 of second electrodialysis part 51.

Repeating the operations from S402 to S411 makes it possible to suppress lowering of the separation performance due to attachment of the fine particles to the ion permeable membrane, and to synthesize fine particles of high quality through stable separation of unreacted raw material ions.

The present disclosure also includes an appropriate combination of appropriate exemplary embodiments and/or examples among the various above-described exemplary embodiments and/or examples, and effects of the respective exemplary embodiments and/or examples can be achieved.

### INDUSTRIAL APPLICABILITY

The microflow synthesis unit according to the present disclosure can control the quality of a desired reaction product to be constant by bringing liquids (reactants) having solubility with each other into contact with each other and mixing the liquids, and the microflow synthesis unit can be applied to, for example, production of fine particles using a hydrothermal synthesis reaction.

### REFERENCE MARKS IN THE DRAWINGS

1 microflow synthesis unit
2 microflow synthesis apparatus
10 first liquid supply part
12 first liquid container
14 first liquid pump
16 first liquid channel
20 second liquid supply part
22 second liquid container
24 second liquid pump
26 second liquid channel
30 mixing channel
31 mixing channel part
40 ion separator
41 cation permeable membrane
42 anion permeable membrane
43 first electrode part
44 first voltage application part
45 second electrode part
46 second voltage application part
47 insulator
49 hole
50 first electrodialysis part
51 second electrodialysis part
60 ionic conductivity detector
70 arithmetic part
80 controller
90 collection part
100 synthetic particle
101 cation
102 anion

1. A microflow synthesis unit comprising:
a mixing channel part for mixing a plurality of fluids to create a mixed fluid including ions;
an ion separator that separates the ions from the mixed fluid, the ion separator being connected downstream of the mixing channel part;
an ionic conductivity detector that detects an ionic conductivity of the mixed fluid, the ionic conductivity detector being connected downstream of the ion separator;
an arithmetic part that calculates an arithmetic value based on the ionic conductivity detected by the ionic conductivity detector; and
a controller that controls the ion separator based on the arithmetic value,
wherein the ion separator includes two or more electrodialysis parts having an electrodialysis function, and
each of the two or more electrodialysis parts includes a corresponding one of two or more voltage application parts.

2. The microflow synthesis unit according to claim 1, wherein
each of the two or more electrodialysis parts further includes:
in a pipe installed in parallel to a channel along a flow direction of the mixed fluid, a cation permeable membrane and an anion permeable membrane that are installed in parallel with the channel interposed therebetween, the cation permeable membrane and the anion permeable membrane being spaced apart from a wall surface of the pipe; and
an electrode part installed on the wall surface of the pipe, and
each of the two or more voltage application parts applies a voltage to the electrode part of the corresponding one of the two or more electrodialysis parts to move ions of the mixed fluid flowing into the pipe to an outside of the cation permeable membrane and the anion permeable membrane.

3. The microflow synthesis unit according to claim 1, wherein
the arithmetic value is a statistic relating to the ionic conductivity, and
the arithmetic part:
sets a threshold value of the ionic conductivity based on the statistic; and
sends a signal to the controller when the ionic conductivity is greater than the threshold value.

4. The microflow synthesis unit according to claim 1, wherein
the microflow synthesis unit further includes a collection part downstream of the ionic conductivity detector, and
the collection part includes:
a channel switch part that switches a channel depending on whether the mixed fluid is a synthetic liquid or a waste liquid based on the ionic conductivity of the mixed fluid detected by the ionic conductivity detector;
a synthetic liquid collection part that collects the synthetic liquid, the synthetic liquid collection part being connected downstream of the channel switch part; and
a waste liquid collection part that collects the waste liquid, the waste liquid collection part being connected downstream of the channel switch part.

5. The microflow synthesis unit according to claim 3, wherein
the microflow synthesis unit further includes a collection part downstream of the ionic conductivity detector, and
the collection part includes:
a channel switch part that switches a channel depending on whether the mixed fluid is a synthetic liquid or a waste liquid based on the ionic conductivity of the mixed fluid detected by the ionic conductivity detector;
a synthetic liquid collection part that collects the synthetic liquid, the synthetic liquid collection part being connected downstream of the channel switch part; and
a waste liquid collection part that collects the waste liquid, the waste liquid collection part being connected downstream of the channel switch part.
